(19) United States
(12) Patent Application Publication
(10) Pub. No.: US 2013/0166337 A1
(43) Pub. Date: Jun. 27, 2013

(54) ANALYZING VISUAL REPRESENTATION OF DATA

(71) Applicant: JOHN MACGREGOR, Ascot (GB)

(72) Inventor: JOHN MACGREGOR, Ascot (GB)

(21) Appl. No.: 13/337,156

(22) Filed: Dec. 26, 2011

(51) Int. Cl. G06Q 10/00

(52) U.S. Cl. 705/7.11

(57) ABSTRACT

In an embodiment, a plurality of representations of business data is rendered on a user interface. The representations of business data may include various graphical representations of the business data. A type of the plurality of representations rendered on the user interface is determined. Based upon the type of the representations, a corresponding statistical analysis is determined and applied to the business data associated with the plurality of representations. Applying the statistical analysis includes computing a resultant for the business data associated with each representation. The resultant of the business data of each representation is compared to determine one or more representations that are statistically distinct. The statistically distinct representations include visually distinct representations in the plurality of representations.

### FIELD

The field generally relates to computer systems and software, and more particularly to methods and systems to analyze the visualize representation of business data.

### BACKGROUND

In current business environment, a user has to consider an enormous amount of business information while making business decisions. Statistical analysis may be helpful in processing the enormous business information and reporting its attributes and behavior over time. An outlier method of observation is a model of statistical analysis that may be applied to the business information of a business case, to determine elements that are distinct from the rest of the information. Outliers may be described as an observation that appears to deviate noticeably from other members of the information in which they occur. A descriptive statistics method called a ‘box-plot’ method may be applied to plot numerical data to determine the observations that may be considered as outliers. There are many models of statistical analysis that are applicable to a single occurrence of business data that represents a single business case. However, providing a mechanism that can act upon multiple occurrences of business data representing multiple business cases and analyzing the multiple occurrences to establish business decisions is useful.

### SUMMARY

Various embodiments of systems and methods to analyze a plurality of representations of business data are disclosed. Representations of business data include visual representations or graphical representations of business data in a form that is perceivable by appearance. For instance, business data may be presented in forms of charts, symbols, images, pictures, topography, numbers, drawings, line arts, and the like, that are understandable by visual examination. In an embodiment, a plurality of representations of business data is rendered on a user interface. Analyzing the representations of business data includes determining visually distinct representations from a group of representations of business data.

To analyze the group of representations rendered on a user interface, a type of the representations is determined. The type of the representations may describe a variety or a class of representations having similar characteristics. For instance, if a user interface renders thirty pie-charts representing business information, the type of representation may be described as chart-type. Based upon the type, a corresponding statistical analysis is applied to the business data associated with the representations. Applying the statistical analysis includes computing a resultant for the business data associated with each representation. The resultant of the business data of each representation is compared to determine one or more representations that are statistically distinct. The statistically distinct representations are visually distinct in the plurality of representations.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIGS. 1A and 1B are graphical user interfaces illustrating a computer implemented method to analyze a plurality of representations of business data, according to an embodiment.

FIGS. 2A and 2B are graphical user interfaces illustrating a computer implemented method to analyze a plurality of representations of business data, according to an embodiment.

FIG. 3 is a process flow diagram illustrating a computer implemented method to analyze a plurality of representations of business data, according to an embodiment.

FIG. 4 is a block diagram illustrating a computer system to analyze a plurality of representations of business data, according to an embodiment.

FIG. 5 is a block diagram illustrating an exemplary computer system, according to an embodiment.

### DETAILED DESCRIPTION

Embodiments of techniques for systems and methods to analyze a plurality of representations of business data are disclosed. In an embodiment, analyzing the representations of business data includes determining visually distinct representations from a group of representations of business data. To analyze the plurality of representations, the associated business data is examined and based upon the examination, visually distinct representations are determined. A computer system may be configured to determine the visually distinct representations by executing corresponding analysis of the associated business data. Determining the visually distinct representations may include configuring the computer system to highlight one or more visually distinct representations, annotating one or more visually distinct representations, marking the visually distinct representations, and the like, based upon the business data, to visually display the distinct representations.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

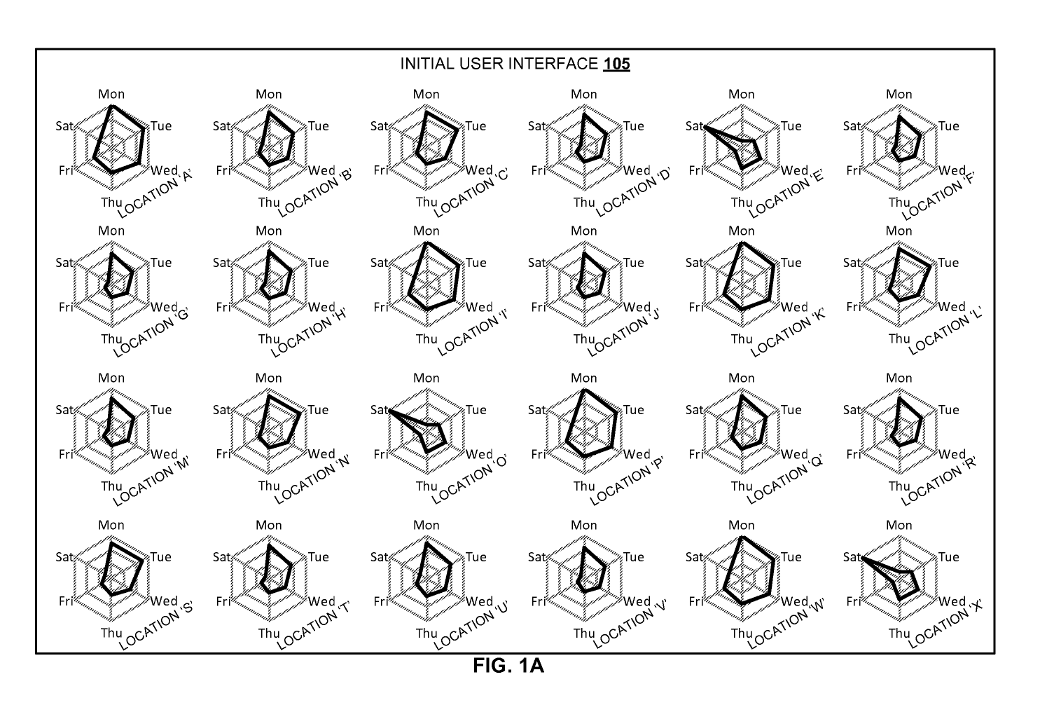

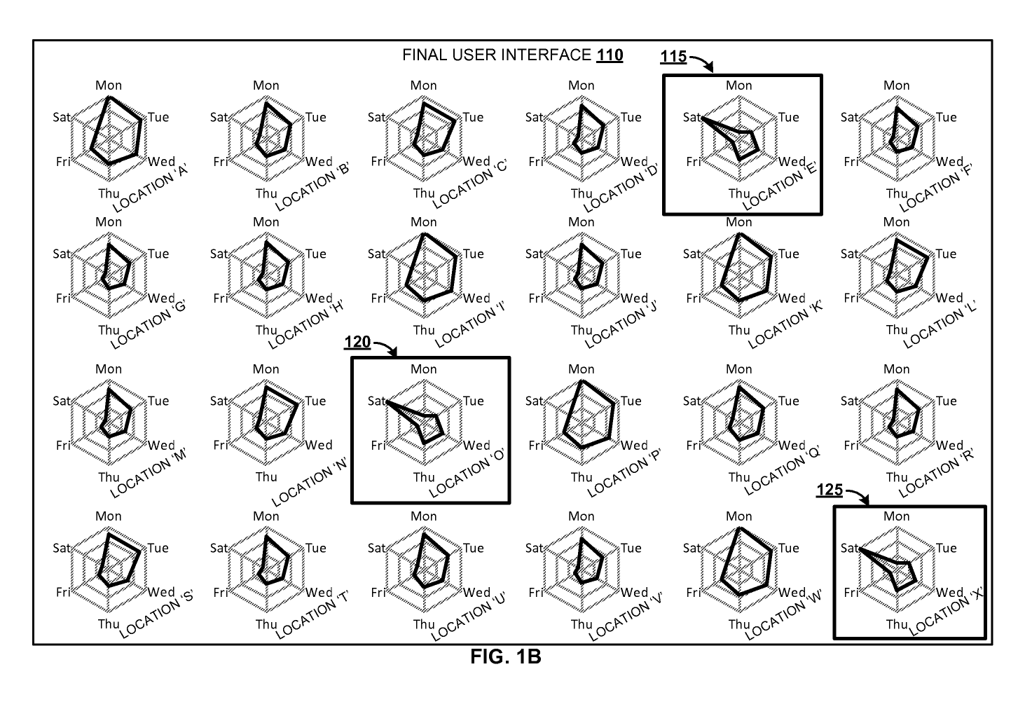

FIGS. 1A and 1B are graphical user interfaces illustrating an overview of a computer system to analyze a plurality of representations of business data, according to an embodiment. Business data may be described as any data that is associated with a corresponding business. Business data may include any information that is relevant for carrying out a business, for instance, production details, sales details, commercial details, market values, marketing expense, turn-over, and the like. This business data may be visually rendered by presenting associated digital information (for e.g. the time taken for production, the revenue generated by sales, the profit earned by sales, etc.) on an output device or a display device in a form that is perceivable or understandable by appearance. The terminologies “digital information” and “business data” may be used interchangeably throughout this description. Representations of business data may be described as a portrayal of the business data in a manner or a form that is visually perceivable. In an embodiment, an image may represent a collection of business data in a perceivable form by depicting all the information included in the business data. For instance, a bar-graph may represent sales information of a product for an entire business year; here, the graph may be described as a representation of the sales information, which is the business data. The sales of the product may be perceivable by the appearance of the graph. Thus, the business data may be presented in forms of charts, symbols, images, pictures, topography, numbers, drawings, line arts, and the like, that are perceivable by appearance.

In an embodiment, a group of one or more such representations of business data are rendered on a user interface (UI), for instance, twenty bar-charts representing twenty business cases of production run of product A. The UI may be a computer generated UI that is executable on the computer. The computer generated UI may further include a current page that is displayed on the computer generated UI, which renders the group of representations of the business data. A current page may be described as an initial page or an initial UI that displays any information (for e.g. representation of business data) as it appears at an initial stage of a process. A final page rendered on the computer generated UI may include any information as it appears at a final stage of a process, for instance an outcome of a process.

For a small collection of visual representations, a visual examination may be executed to determine one or more representations that are different or distinct from the rest of the collection of representations. For example, to determine a distinct representation from a group of four representations of business information, a user may visually examine the four representations and identify the distinct representation. For a large collection of such visual representations, a computer automated statistical analysis may need to be performed. For example, to determine one or more distinct representations from a group of seventy representations of business information, such a computer automated statistical analysis may be needed. In an embodiment, a statistical analysis is performed on the business data associated with the group of representations, to provide a report of any attribute of the information. Performing a statistical analysis may include determining a type of statistical analysis for a corresponding type of representations rendered on the UI. Statistical analysis automated by the computer may include, but not limited to, steps of collection of data, examination of data, summarization of data and interpretation of data to determine associated underlying trends of the data, where trend describes a pattern of gradual change in a process over time.

To analyze the group of representations, a type of the representations is determined. The type of the representation may describe a variety or a class of the representations having similar characteristics or associated with common features. For instance, the business data may be presented as a group of bar-charts, pie-charts, line graphs, or the like. In an embodiment, FIG. 1A includes an initial UI 105, that illustrates a current page displayed on the computer generated UI. The analysis of the business information corresponding to the representations may be triggered by an external entity, the computer, a processor associated with the computer, or the like. Initial UI 105 illustrated in FIG. 1A includes a group of twenty four radar charts representing corresponding business data. Hence, the type of the representations may be addressed as ‘radar-chart’ type, describing the class of the representation. The type of representation may be determined by a processor associated with the computer system or a UI engine associated with the UI.

Based upon the type of representations, a corresponding type of a computer automated statistical analysis is determined. A statistical analysis may be described as a method of establishing statistical business decisions on business data associated with the representations. Statistical analysis is used to explore business data, examine distribution of the business data, summarize the business data to identify patterns of occurrence of data, and the like. An outcome of such computer automated statistical analysis may be described as a resultant, based upon which business decisions are established. For instance, determination of a count of an entity, a maximum or a minimum value from a list of values, a sum of a group values, a mean of values, a variance, a standard deviation, a standard error, a range, and the like are some examples of the resultant.

For each type of representation of business data, a corresponding type of statistical analysis is applied to determine the resultant. The resultant may be used to determine whether business data associated with representations are statistically distinct. A statistical distinctiveness may be described as a means to determine whether the resultant of an analysis is an outcome due to features of the data being analyzed or whether an outcome occurred by chance. Each type of statistical analysis includes corresponding parameters and attributes collectively called metadata, stored in a database. Based upon the type of representation, the processor of the computer system may select the appropriate metadata from the database and execute the corresponding type of statistical analysis. For instance, for the representation type radar-charts, a type of statistical analysis namely T-test is applied; similarly, for the representation type spark-line charts, a statistical analysis namely regressions is applied, and the like. In an embodiment, the computer determines a corresponding type of computer automated statistical analysis based upon the representation type.

The association between the business data corresponding to the type of representation and the statistical analysis may be pre-configured or available in real-time. For instance, a relation between the radar-chart and the T-test may be configured, in order to execute the T-test analysis when radar-chart type representations are encountered by the processor of the computer. Similarly, a relation between the spark-lines and the regressions may be configured, in order to execute the regressions when spark-lines type representations are encountered. In an embodiment, corresponding types of statistical analysis of all the types of representation of business data is stored in a database. In an embodiment, the statistical analysis is applied to the business data associated with the representation based upon the type of representation. In another embodiment, the statistical analysis is applied to the representation based upon the type of business data. The metadata of the statistical analysis include parameters and attributes that describe one or more formulae and procedures to execute the statistical analysis and compute the resultant.

Based upon a determined type of representations, a corresponding type of statistical analysis is identified and extracted by the processor. The statistical analysis associated with the determined type is applied by the computer to the business data associated with each representation of the business data to determine a resultant for the business data associated with each representation. The resultant computed for each representation is further compared with each other, and the resultant that is statistically distinct from the rest of the resultants is determined. For instance, consider a type of statistical analysis “average of a score” applied to business data associated with collection of forty representations of bar-charts. The average of the score is computed to each of the forty representations; and each average is compared with one another. Following table, Table 1 illustrates the average of the score computed for the forty exemplary representations.

TABLE 1

| Chart | Average |
|---|---|
| Number | of score |
| C1 | 85.6 |
| C2 | 88.7 |
| C3 | 83.5 |
| C4 | 27 |
| C5 | 85 |
| C6 | 88 |
| C7 | 87 |
| C8 | 88 |
| C9 | 23 |
| C10 | 85.5 |
| C11 | 88 |
| C12 | 85 |
| C13 | 88.5 |
| C14 | 85.6 |
| C15 | 86.5 |
| C16 | 87.6 |
| C17 | 88.7 |
| C18 | 89.6 |
| C19 | 86.8 |
| C20 | 85 |
| C21 | 26 |
| C22 | 88.5 |
| C23 | 87.7 |
| C24 | 88.9 |
| C25 | 87 |
| C26 | 88 |
| C27 | 20 |
| C28 | 21 |
| C29 | 85 |
| C30 | 85 |
| C31 | 87.6 |
| C32 | 88.7 |
| C33 | 89.6 |
| C34 | 86.8 |
| C35 | 23 |
| C36 | 86 |
| C37 | 26 |
| C38 | 88.5 |
| C39 | 88.7 |
| C40 | 88.9 |

The columns with header “Chart Number” correspond to the identification of the representation of business data on the UI; and the columns with header “Average of score” correspond to the resultant of the analysis. The average of the score of each representation is compared with the other, for instance the average of the score of C1 is compared with the average of the scores of C2, C3, C4, and so on. The comparison resultant of comparison between C1 and C2, C1 and C3 may not yield a statistically distinct resultant since the difference between the averages of the scores is not statistically distinct. For example, the difference between the C1 and C2 is computed as C1˜C2, which equates to 3.1; similarly the difference between C1 and C3 is computed as C1 C3, which equates to 2.1

However, the comparison between C1 and C4 will yield a statistically distinct resultant, since the difference between the averages of the score is statistically high. For example, the difference between C1 and C4 is computed as C1˜C4, which equates to 58.6. Such statistically distinct resultants are determined and classified as statistically distinct business data corresponding to the representations rendered on the UI. Based upon the classification, the representations corresponding to the statistically distinct business data are identified and the identification is visually rendered on the UI. Such visual identifications of statistically distinct representations from a group of representations facilitate the recognition of distinct representations in the group. For instance, the visual identification may include: tagging the representation with an identification name or an identification mark, annotating the representation with a comment on the UI, labeling the representation on UI, visually highlighting the representation on the UI, drawing a boundary line around the statistically distinct representations on the UI, and the like.

FIGS. 1A and 1B illustrate an example of the procedures followed to analyze a plurality of representations of business data. Initial UI 105 displays a plurality of twenty four radar-chart representations of business data EMPLOYEE PRESENCE in various locations of a building (LOCATION A-LOCATION X), recorded for six days in a week (MONDAY, TUESDAY, WEDNESDAY, THURSDAY, FRIDAY and SATURDAY). A radar-chart may be a type of representation that displays multiple variable data in a two-dimensional chart, with the variables plotted on various axes of the chart. The radar chart includes equi-angular spokes or axes, with each spoke representing one variable. A line may be drawn connecting data values for each spoke, resulting in star like or a web like appearance. For instance, the first representation of the twenty four representations of radar-chart in UI 105 illustrates the employee presence recorded for six working days in a week, in the LOCATION A. The radar-chart representation of EMPLOYEE PRESENCE at LOCATION A is associated with business data of the actual number of employees at the workspace on the six days of the week.

Consider the six days, MONDAY, TUESDAY, WEDNESDAY, THURSDAY, FRIDAY and SATURDAY, as six values; and the locations LOCATION A, LOCATION B, LOCATION C, LOCATION D, and LOCATION E as five variables. The following table, Table 2, illustrates the business data associated with the locations for five representations. Each row includes business data associated with the corresponding variable for an entire week along with a mean value or an average value. A similar row exists for each representation including the business data associated with the corresponding representation.

TABLE 2

| | | | Wed | Thu | Fri | Sat | |
|---|---|---|---|---|---|---|---|
| | Mon | Tue | (Value | (Value | (Value | (Value | |
| | (Value A1) | (Value A2) | A3) | A4) | A5) | A6) | Mean |
| Location A | 5 | 13 | 11 | 9 | 7 | 5 | 8.30 |
| (Variable V1) | | | | | | | |
| Location B | 10 | 20 | 30 | 30 | 10 | 60 | 26.67 |
| (Variable V2) | | | | | | | |
| Location C | 25 | 25 | 15 | 12 | 8 | 5 | 15 |
| (Variable V3) | | | | | | | |
| Location D | 22 | 17 | 12 | 9 | 5 | 3 | 11.30 |
| (Variable V4) | | | | | | | |
| Location E | 25 | 20 | 15 | 12 | 8 | 5 | 14.17 |
| (Variable V5) | | | | | | | |

Based upon the type of representation, a corresponding type of statistical analysis is determined in the database, and the statistical analysis associated with the determined type is applied to the business data associated with the representation, to compute the resultant. For a representation of the type RADAR-CHART, a T-TEST type of statistical analysis is applied to the associated business data. According to the T-test, a standard error is calculated for the above values. The standard error is calculated by calculating a sum of six samples business data (A1 to A6) for V1 and V2; determining a mean of the sum of business data for two locations (e.g. V1 and V2); determining a variance of a difference between means of two locations V1 and V2; and determining a standard deviation of the variance and a standard error.

Further, based upon the standard error, a lower confidence interval and an upper confidence interval are computed. The difference between lower confidence interval and the upper confidence interval determines the statistical significance of the data. For instance, if the difference between the lower and the upper confidence intervals is 1.2; the data is not classified as statistically distinct. Similarly, if the difference is 14.2; the data is classified as statistically distinct. The representations of business data that are classified as statistically distinct are rendered on final UI 110 along with a visual identification. FIG. 1B illustrates the visual identification of the statistically distinct representations rendered on final UI 110. Boundary lines 115, 120 and 125 rendered around three representations of business data corresponding to the LOCATION E, O and X in final UI 110 illustrate the statistically distinct representations.

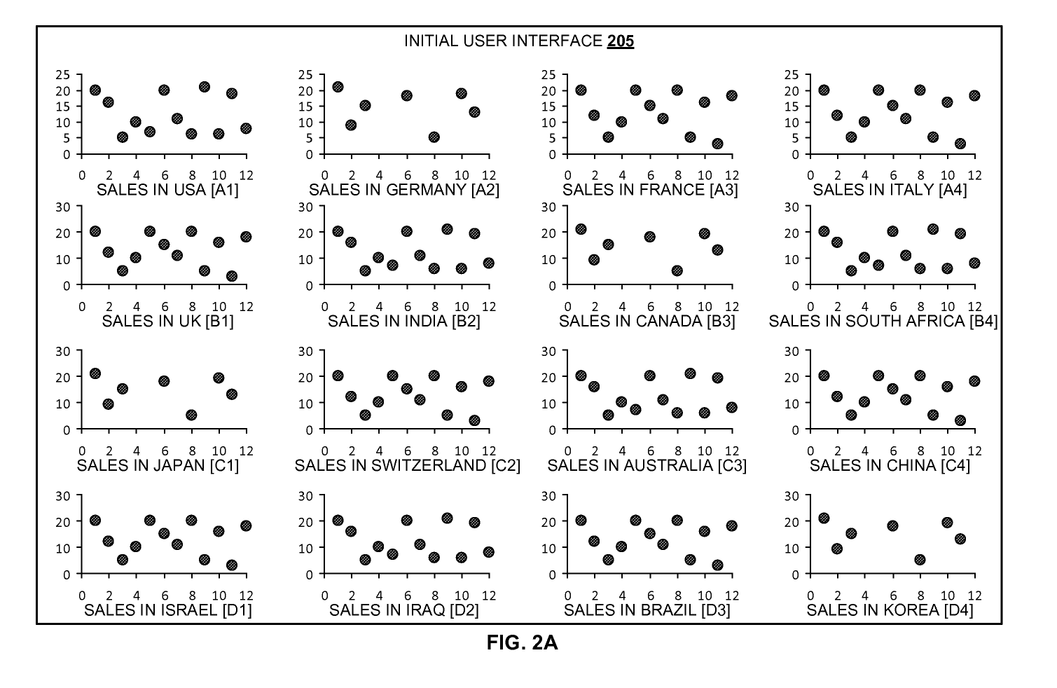

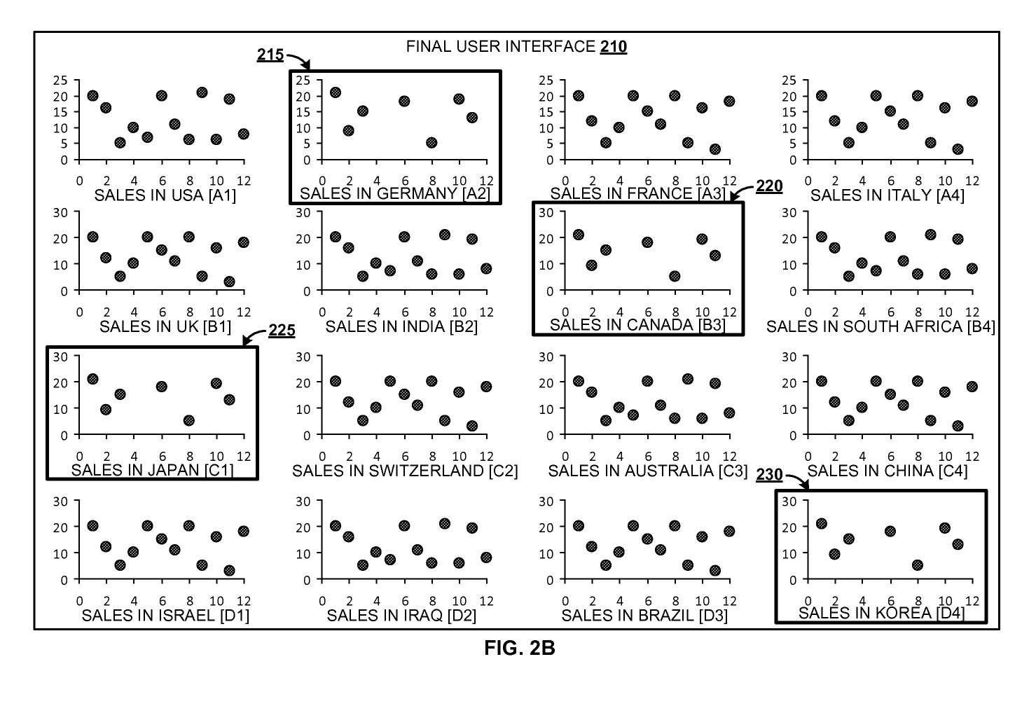

FIGS. 2A and 2B illustrate an example of the procedures followed to analyze a plurality of representations of business data. Initial UI 205 displays a plurality of sixteen scatter chart representations of business data SALES OF PRODUCT ABC recorded for one year at various locations. A scatter chart is a type of representation using Cartesian coordinates to display values of various variables for a set of data. The data is displayed as a collection of points, where each point describes a value of one variable on the x-axis and another variable the y-axis. The scatter chart helps in determining correlation between the variables. For instance, the first representation of the sixteen representations of scatter charts in UI 205 illustrates the sales of three products recorded for twelve months, at the United States of America (USA). The scatter chart representation of SALES OF PRODUCT ABC is associated with business data of actual number of the products sold in the USA, through twelve months.

Consider the twelve months denoted by numbers 1, 2, 3, 4, 5, 6, 7, 8, 9, 10, 11 and 12 (for January, February, March, April, May, June, July, August, September, October, November and December) on x-axis of the chart; and a number of product ABC sold on the y-axis. For the business data corresponding to the scatter chart, the statistical significance may be identified using regression analysis. A trend describes a pattern of gradual change of data over time. Analyzing the trend helps in determining a pattern in the information, predicting future events and estimating events in past. Analyzing the trends also helps in using the historical data to predict a future outcome, and this can be achieved by tracking variances in the data. The business data associated with each representation may be tabulated as shown in the table, Table 3. The rows of the table denote a number of the product ABC sold in a particular region, defined by the first column in each row. The columns of the table denote the number of the product ABC sold in a particular month, defined by the first row in each column.

TABLE 3

| | MONTH | | | | | | | | | | | |
|---|---|---|---|---|---|---|---|---|---|---|---|---|
| REGION | 1 | 2 | 3 | 4 | 5 | 6 | 7 | 8 | 9 | 10 | 11 | 12 |
| USA | 20 | 16 | 5 | 10 | 7 | 20 | 11 | 6 | 21 | 6 | 19 | 8 |
| [A1] | | | | | | | | | | | | |
| GERMANY | 21 | 9 | 15 | 0 | 0 | 18 | 0 | 5 | 0 | 19 | 13 | 0 |
| [A2] | | | | | | | | | | | | |
| FRANCE | 20 | 12 | 5 | 10 | 20 | 15 | 11 | 20 | 5 | 16 | 3 | 18 |
| [A3] | | | | | | | | | | | | |
| ITALY | 20 | 12 | 5 | 10 | 20 | 15 | 11 | 20 | 5 | 16 | 3 | 18 |
| [A4] | | | | | | | | | | | | |
| UK | 20 | 12 | 5 | 10 | 20 | 15 | 11 | 20 | 5 | 16 | 3 | 18 |
| [B1] | | | | | | | | | | | | |
| INDIA | 20 | 16 | 5 | 10 | 7 | 20 | 11 | 6 | 21 | 6 | 19 | 8 |
| [B2] | | | | | | | | | | | | |
| CANADA | 21 | 9 | 15 | 0 | 0 | 18 | 0 | 5 | 0 | 19 | 13 | 0 |
| [B3] | | | | | | | | | | | | |
| SOUTH | 20 | 16 | 5 | 10 | 7 | 20 | 11 | 6 | 21 | 6 | 19 | 8 |
| AFRICA | | | | | | | | | | | | |
| [B4] | | | | | | | | | | | | |
| JAPAN | 21 | 9 | 15 | 0 | 0 | 18 | 0 | 5 | 0 | 19 | 13 | 0 |
| [C1] | | | | | | | | | | | | |
| SWITZER- | 20 | 12 | 5 | 10 | 20 | 15 | 11 | 20 | 5 | 16 | 3 | 18 |
| LAND [C2] | | | | | | | | | | | | |
| AUSTRALIA | 20 | 16 | 5 | 10 | 7 | 20 | 11 | 6 | 21 | 6 | 19 | 8 |
| [C3] | | | | | | | | | | | | |
| CHINA | 20 | 12 | 5 | 10 | 20 | 15 | 11 | 20 | 5 | 16 | 3 | 18 |
| [C4] | | | | | | | | | | | | |
| ISRAEL | 20 | 12 | 5 | 10 | 20 | 15 | 11 | 20 | 5 | 16 | 3 | 18 |
| [D1] | | | | | | | | | | | | |
| IRAQ | 20 | 16 | 5 | 10 | 7 | 20 | 11 | 6 | 21 | 6 | 19 | 8 |
| [D2] | | | | | | | | | | | | |
| BRAZIL | 20 | 12 | 5 | 10 | 20 | 15 | 11 | 20 | 5 | 16 | 3 | 18 |
| [D3] | | | | | | | | | | | | |
| KOREA | 21 | 9 | 15 | 0 | 0 | 18 | 0 | 5 | 0 | 19 | 13 | 0 |
| [D4] | | | | | | | | | | | | |

When the series of sales at each region is analyzed, a trend line is fitted through the data by performing a regression, for example a linear regression. For a simple linear regression, the calculation and the test of significance of the regression is explained by defining the following:

$$Slope B = \frac{( n * \sum xy - \sum x * \sum y )}{( n * \sum {x}^{2} - \sum x * \sum x )}$$

$$Intercept A = \frac{\sum y - b * \sum x )}{n}$$

Here, Σ represents the sums of x and y, xy and x². The variables ‘x’ and ‘y’ denote the location of a data point with reference to x-axis and y-axis.

The overall analysis significance of the regression is computed by using a type of statistical analysis called the F-test, described as:

$$F = \frac{{r}^{2}}{\frac{( 1 - {r}^{2} )}{n - 2}}$$

Here, r is the correlation coefficient and n is the number of data points, and r is further described as:

$$r = \frac{( n * \sum xy - \sum x * \sum y )}{\sqrt{( ( n * \sum {x}^{2} - \sum x \sum x ) * ( n * \sum {y}^{2} - \sum y \sum y ) )}}$$

By referring to F-tables of values, based upon a degree of freedom for two variables x and y, an value′ is determined. An F table is a result of a continuous probability distribution under a null hypothesis. By comparing the F value from the table with the F value determined by the above regression, the statistical significance of the corresponding representation of business data is computed. The statistical significance of each representation of business data is computed based upon the degree of significance of each business data associated with the representation. The representations of the business data that are statistically distinct are rendered on final UI 210 along with a visual identification. FIG. 2B illustrates the visual identification of the statistically distinct representations rendered on final UI 210. Boundary lines 215, 220, 225 and 230 rendered around the four representations of business data corresponding to the location GERMANY in final UI 210 illustrate the statistically distinct representations.

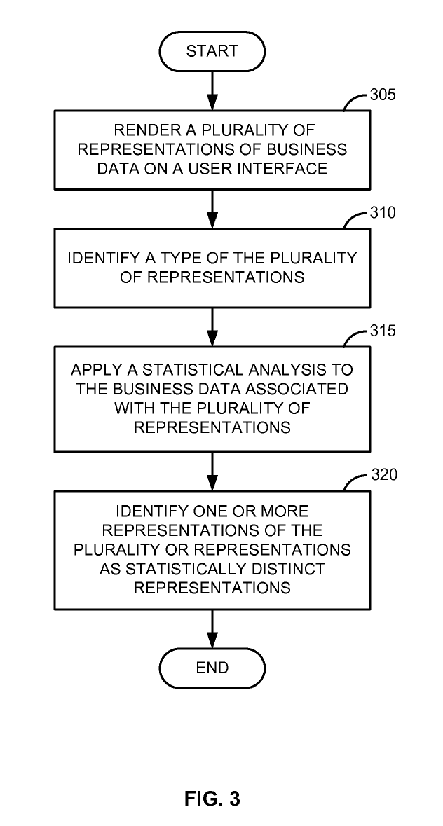

FIG. 3 is a process flow diagram illustrating a computer implemented method to analyze a plurality of representations of business data, according to an embodiment. In process block 305, a plurality of representations of business data is rendered on a user interface (UI). The representations of business data include visual representations or graphical representations of business data in a form that is perceivable by appearance. For instance, business data may be presented in forms of charts, symbols, images, pictures, topography, numbers, drawings, line arts and the like, that are understandable by visual examination. Analyzing a plurality of representations includes determining one or more visually distinct representations of the business data.

In process block 310, a type of the plurality of representations is determined. In an embodiment, a processor associated with the computer may be triggered to determine the type of representations. The type of the representations may describe a class of representations having similar characteristics, for example, similar patterns, similar appearance, similar values, layout, etc. For instance, if a user interface renders thirty radar-charts representing business information, the type of representation may be described as radar-chart type. Based upon the type of the plurality of representations, in process block 315, a corresponding type of statistical analysis is applied to the business data associated with the plurality of representations. Applying the statistical analysis includes computing a resultant for the business data associated with each representation. In an embodiment, applying a statistical analysis further includes determining a type of statistical analysis based upon the type of representations; executing the statistical analysis corresponding to the determined type to compute a resultant for the business data associated with each representation, and comparing the resultant of the business data associated with each representation to determine one or more representations that are statistically distinct.

In an embodiment, executing the determined statistical analysis further includes processing the business data based upon the determined statistical analysis; computing a resultant for the business data corresponding to each representation; and comparing the resultant of each business data to determine one or more business data that are statistically distinct from the business data corresponding to the plurality of representations. The resultant of the business data of each representation is compared to determine one or more representations that are statistically distinct. For the above example of thirty radar-charts, the corresponding type of statistical analysis may include a ‘T-test’. A T-test assesses whether a mean of two groups are statistically different from one another. The T-test may be applied to the business data associated with each representation, and a result may be determined. The result may typically include a determination of whether the two groups are statistically different from one another. This statistical analysis is applied to all the thirty radar-charts rendered on the UI. As a result of the analysis, the processor of the computer may identify one or more of the thirty radar-charts as statistically distinct from the rest of the thirty radar-charts.

Based upon the statistical analysis, in process block 320, one or more representations of the plurality of representations that are statistically distinct are determined. In an embodiment, a UI controller associated with the UI is configured to determine the statistically distinct representations. The statistically distinct representations include visually distinct representations in the plurality of representations. Determining the statistically distinct representations that are visually distinct includes highlighting the statistically distinct representations on the user interface, marking the statistically distinct representations, labeling the statistically distinct representations, and the like. For the above example, an outline may be drawn around each of the statistically distinct representations, and the outline may be rendered on the UI.

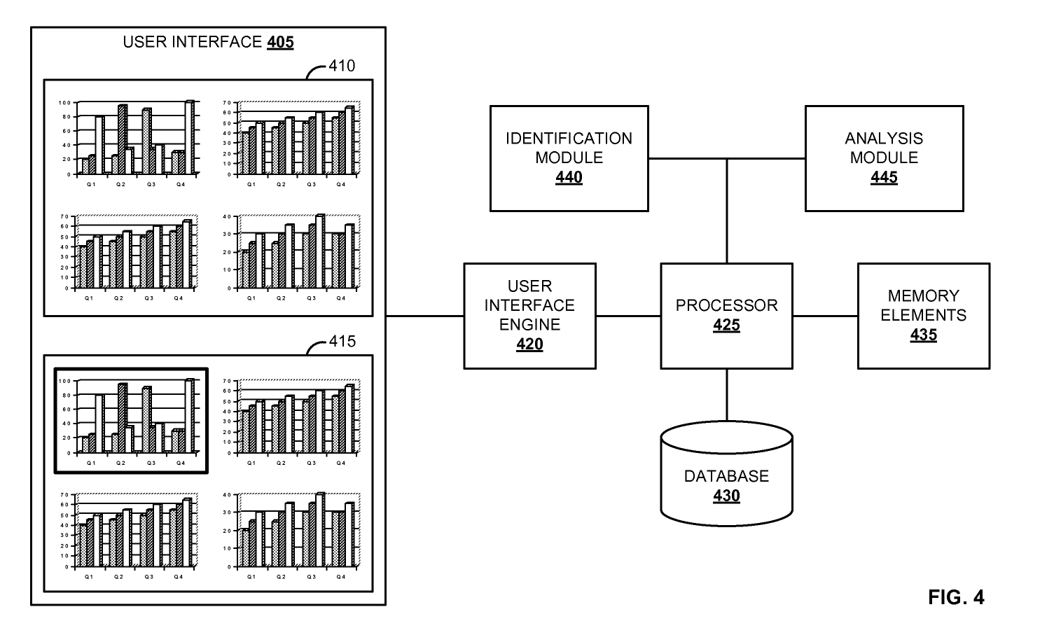

FIG. 4 is a block diagram illustrating a computer system to analyze a plurality of representations of business data, according to an embodiment. System 400 includes user interface (UI) 405, UI engine 420, processor 425, database 430, memory elements 435, identification module 440, and analysis module 445. UI 405 further includes an initial page 410 and a final page 415. In an embodiment, UI 405 is associated with UI engine 425; UI engine 425 is in communication with processor 425; processor 425 is further in communication with database 430 and memory elements 435. Processor 425 reads and executes instructions that are stored in memory elements 435. Memory elements 435 store the instructions to analyze a plurality of representations of business data. UI engine 420 associated with UI 405 is responsible to recognize and receive any input to UI 405, and communicate the received input to processor 420. In an embodiment, UI engine 420 is responsible to receive an instruction to render a plurality of representations of business data on initial page 410. Initial page 410 and initial UI may be used interchangeably throughout this document; similarly, final page 415 and final UI may be used interchangeably throughout this document.

In an embodiment, processor 425 may be triggered by a user or by the computer to render a plurality of representations of business data. UI engine 420 renders an initial UI screen 410 that includes a plurality of representations of business data on UI 405. Identification module 440 determines a type of the plurality of representations rendered on UI 405. Processor 425 may trigger identification module 440 to determine the type of representations based upon an input received on UI 405. Processor 425 determines a corresponding type of statistical analysis for the determined type of the plurality of representations rendered on UI 405. Each type of representation may have a corresponding statistical analysis to determine a resultant. For instance, for representations of the type radar-charts, Chernoff faces, sparkline charts, lattice charts, pie-charts, bar-charts, or the like, database 430 may store metadata to execute T-Test, linear regression, geometric regression, natural log regression, exponential regression, f-test, z-test, and the like. One skilled in the relevant art will recognize various other types of representations rendered on UI 405 and corresponding statistical tests or analysis whose metadata may be stored in database 430.

An association between the representations and the corresponding statistical analysis may be configured by a system developer. In an embodiment, the statistical analysis is determined in real-time, based upon the type of representations. In another embodiment, the statistical analysis is determined from the configured metadata present in database 430. Based upon the type of representation determined by identification module 440, processor 425 determines a type of statistical analysis from the available types of statistical analysis or statistical tests; and applies corresponding test or analysis to determine a statistical significance or the resultant. The statistical significance may be used to compute a distinctiveness of the business data associated with the representations. The statistical significance may be described as a degree of assurance of the distinctiveness that is the outcome of the statistical analysis.

In an embodiment, processor 425 applies the determined statistical analysis to the business data corresponding to the representations rendered on current page 410. Based upon the type of representations and the determined statistical analysis corresponding to the type of representation, analysis module 445 statistically analyses the business data associated with each representation rendered on initial UI 410. Analysis module 445 computes a statistical significance or a resultant for the statistical analysis executed for the corresponding business data. During the execution of the determined statistical analysis, analysis module 445 performs a comparison between the business data of each corresponding representation, and determines one or more representations whose business data are statistically distinct or statistically distinct from the rest of the representations. For instance, analysis module 445 may determine three representations whose corresponding business data are statistically distinct from the rest of the thirty representations of business data. Hence, the three representations corresponding to the three statistically distinct business data are classified as statistically distinct representation of business data.

The determination and classification of the statistically distinct (or significant) business data corresponding to the representations is communicated to UI engine 420 by processor 425. UI engine 420 generates a visual label or a visual identification to render the statistically distinct representations on final page 415, on UI 405. The visual label or visual identification may include: tagging the representation with an identification name or an identification mark, annotating the representation with a comment on UI 415, labeling the representation on UI 415, visually highlighting the representation on UI 415, and the like. On final page 415, the representations are identified by drawing a boundary line around the statistically distinct representations.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

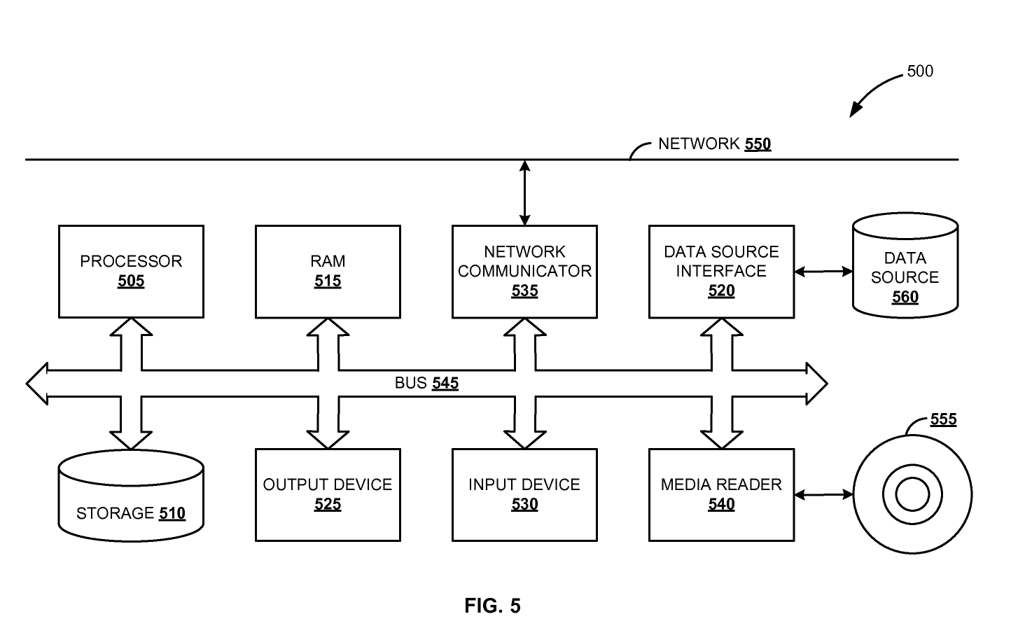

FIG. 5 is a block diagram of an exemplary computer system 500. The computer system 500 includes a processor 505 that executes software instructions or code stored on a computer readable storage medium 555 to perform the above-illustrated methods of the invention. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, continuation servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transaction, hierarchical, multi-dimensional (e.g., OLAP), object oriented databases, and the like. Further data sources include tabular data (e.g., spreadsheets, delimited text files), data tagged with a markup language (e.g., XML data), transaction data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method to analyze a plurality of representations of business data, comprising:
a processor of the computer, determining a type of the plurality of representations rendered on a user interface;
based upon the type of the plurality of representations, the processor of the computer, applying a corresponding statistical analysis to the business data associated with the plurality of representations; and
based upon the statistical analysis, the processor of the computer, determining one or more representations of the plurality of representations as statistically distinct representations of business data, wherein the determined statistically distinct representations are identified as visually distinct from the plurality of representations.

2. The computer implemented method of claim 1, wherein the plurality of representations of business data comprises: a plurality of visual representations of business data.

3. The computer implemented method of claim 1, wherein analyzing a plurality of representations comprise: determining one or more visually distinct representations from the plurality of representations.

4. The computer implemented method of claim 1 wherein the type of the plurality of representations comprises: a class of the plurality of visual representations of the business data associated with one or more common features.

5. The computer implemented method of claim 1, wherein applying a statistical analysis further comprises:
determining a type of statistical analysis based upon the type of representations;
executing the determined type of statistical analysis to compute a resultant for the business data associated with each representation; and
comparing the resultant of the business data associated with each representation to determine one or more representations that are statistically distinct.

6. The computer implemented method of claim 5, wherein executing the determined statistical analysis further comprises:
based upon the determined statistical analysis, processing the business data associated with the representations;
computing the resultant for the business data corresponding to each representation;
comparing the resultant of each business data to determine one or more business data that are statistically distinct from the business data corresponding to the plurality of representations; and
determining the representation corresponding to the statistically distinct business data.

7. The computer implemented method of claim 1, wherein determining the statistically distinct representations comprise: highlighting the statistically distinct representations on the user interface.

8. The computer implemented method of claim 1, wherein the user interface comprises a computer generated user interface executable on the computer, the computer generated user interface comprising:
at least one page displayed as a current page on the computer generated user interface, wherein the current page renders the plurality of representations of the business data; and
a user interface element to render one or more representations of the plurality of representations as statistically distinct, based upon a statistical analysis applied to the business data associated with the plurality of representations, wherein the rendered statistical distinct representations are visually distinct from the plurality or representations.

9. The computer implemented method of claim 8, wherein the user interface element renders the statistically distinct representations by marking the statistically distinct representations on the computer generated user interface.

10. The computer implemented method of claim 1 further comprising:
determining a class of one or more graphical representations rendered on the user interface;
based upon the class of the graphical representations, implementing a statistical analysis to the business data corresponding to the graphical representations, to compute an resultant, by
determining the statistical analysis based upon the class of the graphical representations,
executing the statistical analysis to compute the resultant for each business data associated with the graphical representation;
comparing the resultant of each representation to determine one or more business data that are statistically distinct; and
labeling the statistically distinct determined graphical representations on the user interface.

11. An article of manufacture including a computer readable storage medium to tangibly store instructions, which when executed by a computer, cause the computer to:
to transform a type of the plurality of representations rendered on a user interface;
based upon the type of the plurality of representations, to apply a corresponding statistical analysis to the business data associated with the plurality of representations; and
based upon the statistical analysis, to determine one or more representations of the plurality of representations as statistically distinct representations of business data, wherein the determined statistically distinct representations are visually distinct from the plurality of representations.

12. The article of manufacture of claim 11 further comprising instructions which when executed by the computer, cause the computer to:
determine a class of one or more graphical representations rendered on the user interface;
based upon the class of the graphical representations, implement a statistical analysis to the business data corresponding to the graphical representations, to compute an resultant, by
determining the statistical analysis based upon the class of the graphical representations,
executing the statistical analysis to compute the resultant for each business data associated with the graphical representation;
compare the resultant of each representation to determine one or more business data that are statistically distinct; and
label the statistically distinct determined graphical representations on the user interface.

13. The article of manufacture of claim 11, wherein the user interface comprises a computer generated user interface executable on the computer, the computer generated user interface causes comprises:
at least one page displayed as a current page on the computer generated user interface, wherein the current page renders the plurality of representations of the business data;
a user interface element to render one or more representations of the plurality of representations as statistically distinct based upon a statistical analysis applied to the business data associated with the plurality of representations, wherein the rendered statistical distinct representations are visually distinct from the plurality or representations.

14. A computer system to analyze a plurality of representations of business data, comprising:
a processor to read and execute instructions stored in one or more memory elements; and
the one or more memory elements storing instructions to:
a user interface engine, to render the plurality of representations of business data on a user interface;
an identification module, to determine a type of the plurality of representations rendered on the user interface;
an analysis module, to statistically analyze the business data associated with the plurality of representations, based upon the type of analysis;
the processor, to determine one or more representations of the plurality of representations as statistically distinct based upon the statistical analysis, wherein the determined statistically distinct representations are visually distinct from the plurality of representations.

15. The computer system of claim 14, wherein the user interface engine renders a plurality of visual representations of business data on the user interface.

16. The computer system of claim 14, wherein the analysis module
determines a type of statistical analysis based upon the type of representations;
executes the determined type of statistical analysis to compute an resultant for the business data associated with each representation; and
compares the resultant of the business data associated with each representation to determine one or more representations that are statistically distinct.

17. The computer system of claim 14, wherein the user interface engine highlights the statistically distinct representations on the user interface.

18. The computer system of claim 14, wherein the user interface engine renders a computer generated user interface executable on the computer, the computer generated user interface includes:
at least one page rendered by the user interface engine as a current page on the computer generated user interface, wherein the current page renders the plurality of representations of the business data; and
a user interface element to render one or more representations of the plurality of representations as statistically distinct, based upon a statistical analysis applied to the business data associated with the plurality of representations, wherein the rendered statistical distinct representations are visually distinct from the plurality or representations.

19. The computer system of claim 14, wherein the processor determines a class of one or more graphical representations rendered on the user interface;
based upon the class of the graphical representations, implements a statistical analysis to the business data corresponding to the graphical representations, to compute an resultant, by
determining the statistical analysis based upon the class of the graphical representations,
executing the statistical analysis to compute the resultant for each business data associated with the graphical representation;
compares the resultant of each representation to determine one or more business data that are statistically distinct; and
labels the statistically distinct determined graphical representations on the user interface.
